(19) United States
(12) Patent Application Publication
(10) Pub. No.: US 2024/0144610 A1
(43) Pub. Date: May 2, 2024

(54) SYSTEM AND METHOD FOR OVERLAYING A HOLOGRAM ONTO AN OBJECT

(71) Applicant: The Royal Institution for the Advancement of Learning/McGill University, Montreal (CA)

(72) Inventors: Swajan Paul, Montreal (CA); Antonia Arnaert, Verdun (CA); Zoumanan Debe, Nepean (CA)

(73) Assignee: The Royal Institution for the Advancement of Learning/McGill University, Montreal, QC (CA)

(21) Appl. No.: 18/384,747

(22) Filed: Oct. 27, 2023

Related U.S. Application Data
(60) Provisional application No. 63/381,432, filed on Oct. 28, 2022.

(51) Int. Cl. G06T 19/00; G02B 27/01

(52) U.S. Cl. CPC G06T 19/006; G02B 27/0103

(57) ABSTRACT

A method for overlaying an image on a physical object is described. The method includes: instantiating a common coordinate system that unifies a first coordinate system and a second coordinate system; dynamically recognizing the physical object in the common coordinate system using at least one sensor; aligning an image map with a model map of the dynamically recognized physical object in the common coordinate system; and displaying the image in a physical space overlaid on the physical object using a display of an extended reality (XR) device. A corresponding system and a computer-readable medium are also described.

### CROSS REFERENCE TO RELATED APPLICATION

The present application claims the benefit of, and priority to, U.S. Provisional Application No. 63/381,432 filed on Oct. 28, 2022, and entitled SYSTEM AND METHOD FOR OVERLAYING A HOLOGRAM ONTO AN OBJECT, the entirety of which is hereby incorporated by reference.

### TECHNICAL FIELD

The technical field relates to augmented reality, and more specifically to systems and methods for tracking real-world objects and overlaying holograms onto real-world objects.

### BACKGROUND

The current practices of surgical procedures require absolute patient-specific knowledge of the anatomy of the surgical site which helps to create pre-operative planning according to the pathological diagnosis of the patient. Though the ongoing medical imaging practices create advancements in anatomical identification, diagnosis, and pre-operative planning of a surgical procedure, it has been currently lacking the integration of the patient-specific guidance into the surgical site during a surgical procedure. From the last decades, the question of integration of patient-specific diagnostic information and surgical guidance came into the air and augmented reality has been considered as the best way to integrate it into the field of surgery. The potential adaptability of augmented reality in surgery has redefined some fundamental aspects of the surgical procedures in the operating room. This adaptability creates a direct intra-operative spatial relationship between the surgeon and the site of operation during a surgical procedure. The site of operation has been expanded with patient-specific imaging information and the surgeon gets access into the augmented field of surgical procedure which is created with 3D holograms from pre-operative patient-specific CT or MRI scans. The real-time recognition of the surgical site and environment in the operating room is the basis of this patient-specific intra-operative augmentation. Existing systems and methods do not offer sufficient accuracy to allow for the identification and creation of the right trajectory of surgical procedures such as pedicle screw placement. There is therefore a need for improving the accuracy of the overlaying holographic virtual model into the real anatomy of the region of interest during surgery. Surgery is one field where accuracy is of the outmost importance, but it can be appreciated that systems and methods with improved accuracy could also advantageously be used in a variety of fields where holograms ought to be projected onto precise locations of objects.

### SUMMARY

According to an aspect, a method for mapping coordinates to a common coordinate system is provided. The method includes: 1) converting a model of an object to a model map, wherein coordinates of the model map correspond to a world coordinate system; 2) converting an image to an image map, wherein the image is a representation of the object and wherein coordinates of the image map correspond to a hologram coordinate system; 3) generating an identity matrix; generating a transform matrix by applying at least one rotation about at least one axis to the identity matrix, so that the transform matrix encodes the at least rotation; 4) converting the transform matrix to a quaternion, wherein the quaternion encodes the at least one rotation; recognizing common features in the image and in the model; extracting hologram coordinates and world coordinates of significant points from the common features; computing, from the hologram coordinates and the world coordinates of the significant points, a transformation, wherein applying the transformation to the model map results in the coordinates of the model map corresponding to the hologram coordinate system; 5) generating an origin of the common coordinate system at a positional value of the transformation and a rotational value of the quaternion; computing a hologram transformation applicable to represent the image in the common coordinate system from hologram coordinates of the common features recognized in the image; and 6) computing a world transformation applicable to represent the model in the common coordinate system from world coordinates of the common features recognized in the model.

According to an aspect, a system is provided for overlaying an image onto an object, wherein the image is a representation of the object. The system includes: a sensor configured to capture a model from the object; a computer-readable memory comprising instructions which, when executed by at least one processor, cause the at least one processor to perform the method described above; and a light-emitting device configured to display a hologram corresponding to the image overlaid onto the object.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is a schematic of a system for overlaying an image onto an object, according to an embodiment.

FIG. 2 is a flowchart of a method for mapping coordinates to a common coordinate system to overlay an image onto an object, according to an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

One or more systems described herein may be implemented in computer program(s) executed on processing device(s), each comprising at least one processor, a data storage system (including volatile and/or non-volatile memory and/or storage elements), and optionally at least one input and/or output device. “Processing devices” encompass computers, servers and/or specialized electronic devices which receive, process and/or transmit data. As an example, “processing devices” can include processing means, such as microcontrollers, microprocessors, and/or CPUs, or be implemented on field programmable gate arrays (FPGAs). For example, and without limitation, a processing device may be a programmable logic unit, a mainframe computer, a server, a personal computer, a cloud based program or system, a laptop, a personal data assistant, a cellular telephone, a smartphone, a wearable device, a tablet, a video game console or a portable video game device.

Each program is preferably implemented in a high-level programming and/or scripting language, for instance an imperative e.g., procedural or object-oriented, or a declarative e.g., functional or logic, language, to communicate with a computer system. However, a program can be implemented in assembly or machine language if desired. In any case, the language may be a compiled or an interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is, of course, chosen according to the desired use, whether it should retain instructions, or temporarily store, retain or update data. Steps of the proposed method are implemented as software instructions and algorithms, stored in computer memory and executed by processors.

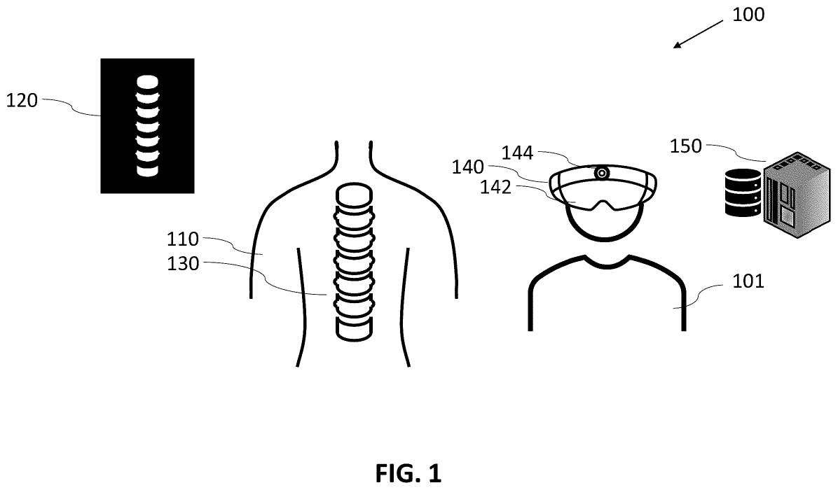

With reference to FIG. 1, an exemplary system 100 for overlaying an image onto an object is shown according to an embodiment. In the illustrated embodiment 100, a hologram 130 corresponding to an image 120 is overlaid onto a real-world object 110 through a head-mounted display 140. In the present embodiment, the image 120 corresponds to a visualization of object 110, such as a visualization that includes information not visible through the naked eye.

FIG. 1 illustrates an example where the object 110 is a patient undergoing a surgical procedure, and the image 120 is a radiological image showing bones or other organs of the patient, taken with a radiological imaging device during or shortly before the procedure. As an example, the patient may be undergoing a spinal fusion surgery requiring the insertion of pedicle screws, and the image may be a computed tomography (CT) scan of the patient's spine obtained with a CT scanner. A hologram 130 of the CT scan is overlaid onto the patient's back for the benefit of the surgeon.

Although in the present embodiment the system 100 is described in connection with projecting a hologram of a CT scan to assist with a spinal surgery procedure, it is appreciated that other configurations are possible. As an example, alternative embodiments of system 100 could be used to overlay holograms corresponding to different types of images, such as a thermal image in false colours acquired with an infrared thermographic camera. Moreover, the system 100 can be used in other contexts, for example to overlay a hologram on a mechanical system e.g., for the benefit of a repair person.

Object 110 is a physical “real-world” element that occupies a volume in the physical space where system 100 operates, and is a target onto which additional information from an image 120 is to be projected as a hologram 130 via head-mounted display 140 for the benefit of a user 101 utilizing the system. Object 110 can be stationary or moving. Similarly, head-mounted display 140 can move relative to object 110. The system 100 can therefore be configured to track the position of object 110 so that hologram 130 can be projected correctly.

Image 120 is a digital or digitalized image that represents information about object 110. Image 120 can be a two-dimensional or a tridimensional image. In some embodiments, image 120 is a representation of object 110 according to a certain perspective. Image 120 can be a representation of object 110 that contains information not visible to the naked eye of the user 101. For instance, image 120 can be constructed by a sensor arrangement capable of perceiving light waves in wavelengths not visible to the human eye, e.g., infrared or ultraviolet light, and/or waves that are not light waves, e.g., electromagnetic radiation or radio waves such as generated by a radiological imaging device. As an example, image 120 can be a radiological image that represents features of object 110 that can be discerned with radiological imaging.

Image 120 is used to create a hologram 130. The word “hologram” is used in a broad sense to encompass any virtual object that can be virtually or physically projected into a physical space and overlaid on a target real-world object 110. A hologram can correspond to a “real” hologram that can for instance be projected as interference patterns to create tridimensional physical structures in the space of where system 100 operates, or a “false” hologram that can for instance be rear-projected onto a semi-transparent screen strategically positioned to create the illusion of a real hologram for the user 101. In some embodiments, the hologram can be presented as a 2D image physically projected on object 110, and whose perspective can be updated as the user 101 moves relative to object 110 such that a tridimensional illusion can be created. In the present embodiment, a head-mounted display 140 is provided to produce a false hologram by virtually projecting hologram 130 in a field of view of the user 101 while the user wears the head-mounted display 140. Although a head-mounted display is described, it is appreciated that other extended reality (XR) devices that enable mixing digital images with real-world content are also possible, such as augmented reality (AR), virtual reality (VR) and/or mixed reality (MR) devices.

Image 120 and corresponding hologram 130 can be converted to an image map, for instance by applying rasterization to image 120 if it is not already a bidimensional or tridimensional raster graphic. A bidimensional image of size W×H can therefore correspond to a matrix of size W×H, and a tridimensional image of size W×H×D can correspond to a tensor of size W×H×D. Each pixel of a bidimensional image can therefore be designated by its coordinates (x, y) in the corresponding matrix image map. Similarly, each voxel of a tridimensional image can be designated by its coordinates (x, y, z) in the corresponding tensor image map. The image map is therefore represented in a coordinate system, which can be referred to as the hologram coordinate system.

In the present embodiment, a head-mounted display 140 (HMD) is provided to be worn by the user 101. The HMD 140 can for instance include a light-emitting device such as a projector and a semi-transparent screen 142 positioned in front of the eyes of the wearer, such that image 120 is projected on screen 142 by the light-emitting device. Screen 142 can be configured so that the wearer of the HMD has an unimpaired view of object 110 but also reflects the projection of image 120, creating for the wearer the illusion of a hologram 130 being projected onto object 110. Examples of commercially available HMD equipment include Microsoft HoloLens, Magic Leap One and Google Glass.

To track object 110 and ensure a correct overlaying, a sensor or a configuration of multiple sensors can be used. Moreover, when hologram 130 is being projected in the perspective of a user 101, for instance when it is being projected on the screen 142 of a HMD 140, the position of the user (i.e. the position and orientation of the HMD) can be taken into account. In some embodiments, a sensor used to track the object 110 and/or the position of user 101 can be a video camera 144. In some embodiments, a camera can be mounted at a fixed location in the physical space of system 100 to track the object 110 and/or the user. Alternatively, or additionally, a camera 144 can be attached to the user. For instance, when the user is wearing a HMD 140, camera 144 can be mounted or integrated in the HMD 140. The camera(s) can for instance be configured to capture visible light and/or infrared light. The camera(s) can be configured to capture a single image and/or to capture at least two images that can be used to infer the depth of the objects visible in the capture, for instance the depth of each pixel associated to object 110, creating a tridimensional image. In some embodiments, at least two cameras can be mounted at a known distance from one another, e.g., to function as a stereo camera, creating at least two images that can be used to infer depth. In some embodiments, HMD 142 can include other sensors, such as one or more gyroscope operating as a tilt sensors, capable for instance of detecting the orientation of the head of the HMD wearer with respect to object 110. In some embodiments, a distance measuring device, for instance one or more ultrasonic sensors, can alternatively or additionally mounted at a fixed location in the physical space of system 100 and/or on the HMD 140.

The readings of a given sensor, such as camera 144, correspond to a representation of the “real” world in the physical space of system 100 centred on real-world object 110. When multiple sensors are used, their readings can be aggregated to create a single representation of the real world. This representation corresponds to the model of the real-world object 110, and is used to track the object in order to overlay the hologram 130 onto said real world object. The representation can be bidimensional, for instance if it is created from the capture of a conventional camera with no postprocessing applied, or tridimensional, for instance if it is created from the capture of a stereo camera with postprocessing being applied to infer depth from the disparity between the two captured images. The representation corresponds to a model map, which can therefore be bidimensional or tridimensional. A bidimensional model map can correspond to a matrix of size W×H, and a tridimensional model map can correspond to a tensor of size W×H×D. Each pixel of a bidimensional model can therefore be designated by its coordinates (x, y) in the corresponding matrix image map. Similarly, each voxel of a tridimensional model can be designated by its coordinates (x, y, z) in the corresponding tensor image map. The image map is therefore represented in a coordinate system, which can be referred to as the world coordinate system.

It can be appreciated that the coordinates of features of object 110 in the world coordinate system and the coordinates of corresponding features in hologram 130 in the hologram coordinate system do not automatically correspond. In order for the hologram 130 to be correctly overlaid onto the object 110, a mapping from one coordinate system to the other can be inferred, or a common coordinate system can be established.

The system 100 can include at least one processing device 150, including a processor and memory storing instructions which, when executed, cause the processor to carry out a method for mapping coordinates from one coordinate system to another coordinate system. In some embodiments, the at least one processing device 150 can be integrated and/or embedded as part of the HMD 140, while in other embodiments the at least one processing device 150 can be a separate device that is in communication with the HMD 140.

The instructions stored and executed by processing device 150 can cause the system 100 to carry out a method for overlaying an image onto an object. Broadly described, the method can include initiating a common coordinate system (CCS) that unifies first and second coordinate systems, such as a world coordinate system (WCS) and a holographic coordinate system (HCS). The WCS corresponds to a coordinate system anchored in the real world and that can represent the position and/or orientation of physical or virtual objects in a physical space, and the HCS corresponds to a separate coordinate system that can represent the relative position and/or orientation of virtual objects or holograms in a virtual space. Once the CCS has been established, dynamic recognition of a target object (e.g., as detected by camera 144) can be carried out in the CCS to superimpose one or more virtual objects or holograms onto the target object. For example, a feature selection process can calculate parameters to match the virtual and target objects in the CCS, and a computational process can determine interactive positions of the virtual and target objects. The positional values of both the virtual and target objects can be established initially (e.g., via a gaze initiation process), and the positional values can be subsequently updated with positional and rotational changes in the target object (e.g., as the target object moves and/or a user moves relative to the target object) to allow superimposition of the virtual object relative to the target object through spatial mapping.

In some embodiments, processes that are carried out in different coordinate systems (such as the WCS and/or HCS) can instead be carried out in the CCS. For example, a holographic tracking or spatial mapping process can be carried out to generate a representation of real-world surfaces in the physical space and allow placing virtual objects therein. Corresponding computations that are normally carried out in the HCS are instead carried out in the CCS. As another example, a reference model recognition process can be carried out to recognize a target object and generate a corresponding virtual model thereof (for example represented as a model map). Corresponding computations that are normally carried out in the HCS are instead carried out in the CCS. As a further example, a run-time parameter tracking process can be carried out to select features of the reference model that can subsequently be matched with corresponding features of a virtual object (for example represented as an image map) to allow aligning the virtual object with the target object (e.g., as represented by the model map). Corresponding computations that are normally carried out in the WCS are instead carried out in the CCS, allowing to select features that are represented in the CCS, and allowing dynamic recognition of the virtual object to be established in the CCS.

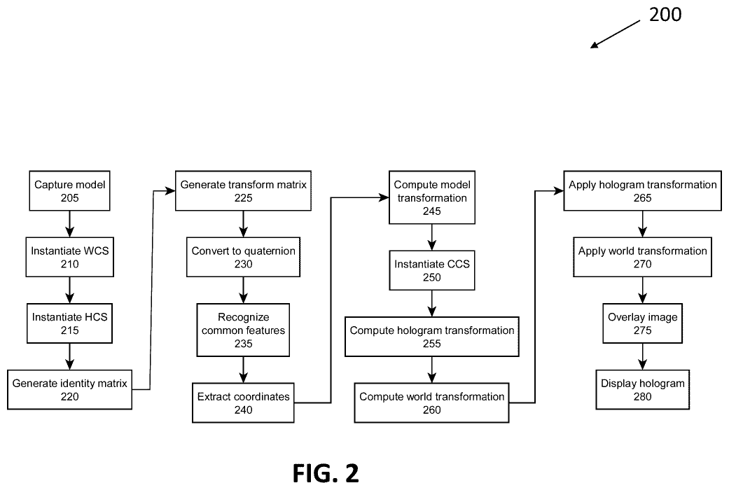

With reference to FIG. 2, an exemplary method 200 for overlaying an image onto an object is shown according to an embodiment.

Some steps in method 200 include applying transformation to a map, i.e., to the image and/or the model. Transformations can for instance include translations, rotations, Euclidian transformations combining translations and rotations, and/or scaled rotations. Transformations can be applied to a map using one coordinate system to convert it into a map using another coordinate system. Applying a transformation to a map can be performed by applying a corresponding transformation to the coordinates of each pixel or voxel, thereby determining the new coordinates of the pixel or voxel. As examples, in a tridimensional map:
a translation can be represented as a size 3 translation vector, its application to each voxel being the sum of the size 3 vector corresponding to the voxel coordinates and the translation vector;
a rotation can be represented as a 3×3 rotation matrix, for instance

$$[ \begin{matrix}cos θ & - sin θ & 0 \\ sin θ & cos θ & 0 \\ 0 & 0 & 1\end{matrix} ]$$

representing a θ rotation around the z-axis, its application to each given voxel (x, y, z) corresponding to the product of the rotation matrix and

$$[ \begin{matrix}x \\ y \\ z\end{matrix} ] ;$$

a rotation can alternatively be represented as a quaternion, for instance

$$( cos \frac{θ}{2} , 0 , 0 , sin \frac{θ}{2} )$$

representing a θ rotation around the z-axis, its application to each given voxel (x, y, z) corresponding to the product of the quaternion inverse, (0, x, y, z), and the quaternion; and
a Euclidian transformation can be represented as a 4×4 transform matrix, for instance

$$[ \begin{matrix}cos θ & - sin θ & 0 & {t}_{x} \\ sin θ & cos θ & 0 & {t}_{y} \\ 0 & 0 & 1 & {t}_{z} \\ 0 & 0 & 0 & 1\end{matrix} ]$$

representing a θ rotation around the z-axis and a (tₓ, t_{y}, t_{z}) translation, its application to each given voxel (x, y, z) corresponding to the product of the transform matrix and

$$[ \begin{matrix}x \\ y \\ z \\ 1\end{matrix} ] .$$

A first step 205 can include receiving a model of the object onto which a hologram is to be overlaid. The model of the object can be received following constructing of the model using sensor readings, such as readings from a conventional or a stereo camera and/or aggregated readings of more than one sensor. For example, in the present embodiment, the model is constructed at least in part using video camera 144 integrated in the HMD 140.

A next step 210 can include converting the model into a bidimensional or tridimensional raster model map. In some embodiments, step 210 can include the sub-step of inferring a depth of each pixel of a bidimensional model map using known depth estimation techniques to create a tridimensional model map. The coordinates of the pixels or voxels in the model map can be represented in a first coordinate system, such as the WCS.

A next step 215 can include converting the image to be overlaid onto the object into a bidimensional or tridimensional raster image map. The coordinates of the pixels or voxels in the image map can be represented in a second coordinate system that is different than the first coordinate system, such as the HCS.

A next step 220 can include generating an identity transformation applicable to a map in either coordinate system, such as an identity transform matrix I₄, corresponding to a null Euclidian transformation in the WCS.

A next step 225 can include generating a transform matrix by applying at least one rotation to the identity transformation generated at step 220. As an example, one or more of a 90-degree rotation around a z-axis, a 180-degree rotation around the z-axis, a 270-degree rotation around the z-axis, and a 180-degree rotation around a y-axis can be applied to the transform matrix during step 225.

A next step 230 can include converting the transform matrix generated at step 225 in a quaternion encoding the same rotation(s) as encoded in the transform matrix. This can for instance include extracting the 3×3 rotation matrix corresponding to the first three lines and columns of the 4×4 transform matrix and using known techniques to convert the rotation matrix to a quaternion.

A next step 235 can include recognizing corresponding features in the model and in the image using known feature detection and matching techniques such as line gradient thresholds, Laplace thresholds and line search length gradient values that will be recognized and preserved for use in step 240.

A next step 240 can include, for each corresponding feature identified at step 235, extracting significant points with matching technique parameter values identified at step 235, each corresponding to a pixel or a voxel representing the same significant point of the same feature in both the model map and the image map. Step 240 can therefore include extracting a pair of coordinates for each significant point, each pair containing coordinates representing positions in the WCS and in the HCS. The pair of coordinates can include first coordinates that correspond to coordinates of the significant points in the image map in the HCS, and second coordinates that correspond to coordinates of the significant points in the model map in the WCS.

A next step 245 can include, using the pairs of coordinates extracted at step 240, computing a transformation corresponding to a mapping from the significant point coordinates identified in the model to the corresponding significant point coordinates identified in the image. This transformation can be applied to the model using the WCS in order to obtain a corresponding model using the HCS. The transformation can thus represent positional value differences between the WCS and HCS.

A next step 250 can include instantiating a common coordinate system (CCS) for unifying the WCS and the HCS. The CCS can be instantiated by generating an origin of the CCS, such as a new original coordinate (0,0,0), at the positional value of the transformation computed at step 245 and a rotational value of the quaternion obtained at step 230.

A next step 255 can include computing a hologram transformation corresponding to a mapping from the significant point coordinates identified in the image to the corresponding significant point coordinates in the CCS. This transformation can be applied to the image using the HCS, resulting in a corresponding image using the CCS.

A next step 260 can include computing a world transformation corresponding to a mapping from the significant point coordinates identified in the model to the corresponding significant point coordinates in the CCS. This transformation can be applied to the model using the WCS, resulting in a corresponding model using the CCS.

A next step 265 can include mapping the coordinates of the image map to the CCS by applying the hologram transformation computed at step 255 to the image, resulting in an image using the CCS.

A next step 270 can include mapping the coordinates of the model map to the CCS by applying the world transformation computed at step 260 to the model, resulting in a model using the CCS.

A next step 275 can include overlaying the image using the CCS obtained at step 265 onto the model using the CCS obtained at step 270, which consists in overlaying each image pixel (iₓ, i_{y}) or voxel (iₓ, i_{y}, i_{z}) onto the corresponding model pixel (mₓ, m_{y}) or voxel (mₓ, m_{y}, m_{z}) where, given that both use the CCS, iₓ=mₓ, i_{y}=m_{y} and, where both the image and the model are tridimensional, i_{z}=m_{z}.

Finally, a next step 280 can include displaying a hologram corresponding to the image overlaid onto the object by using the CCS. The hologram can, for example, be displayed using HMD 144 or another suitable device. As can be appreciated, at least some of the steps mentioned above can be repeated as needed to maintain an alignment of the objects and hologram as the object and/or HMD 144 move relative to one another.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A method for overlaying an image represented as an image map in a first coordinate system on a physical object represented as a model map in a second coordinate system, the method comprising:
instantiating a common coordinate system that unifies the first coordinate system and the second coordinate system;
dynamically recognizing the physical object in the common coordinate system using at least one sensor;
aligning the image map with the model map of the dynamically recognized physical object in the common coordinate system; and
displaying the image in a physical space overlaid on the physical object using a display of an extended reality (XR) device.

2. The method according to claim 1, wherein instantiating the common coordinate system comprises calculating a transforming point value and rotational value between the first coordinate system and the second coordinate system, and generating an origin coordinate of the common coordinate system at the transforming point value by means of the rotational value.

3. The method according to claim 2, wherein calculating the transforming point value comprises:
recognizing common features in the image and the physical object;
extracting first coordinates in the first coordinate system, the first coordinates corresponding to significant points of the common features in the image map;
extracting second coordinates in the second coordinate system, the second coordinates corresponding to the significant points of the common features in the model map; and
obtaining the transforming point value by computing positional differences between the first coordinates and the second coordinates.

4. The method according to claim 3, wherein recognizing common features comprises applying at least one of line gradient thresholds, Laplace thresholds and line search length gradient values.

5. The method according to claim 3, further comprising:
computing a first transformation corresponding to a mapping from the significant points of the common features in the image map to coordinates of corresponding significant points in the common coordinate system; and
computing a second transformation corresponding to a mapping from the significant points of the common features in the model map to the coordinates of corresponding significant points in the common coordinate system.

6. The method according to claim 5, comprising:
dynamically generating a model of the physical object using the at least one sensor, the model being represented by the model map in the second coordinate system;
applying the first transformation to the image map to bring the image map into the common coordinate system;
applying the second transformation to the model map to bring the model map into the common coordinate system; and
dynamically aligning the image map with the model map.

7. The method according to claim 2, wherein calculating the rotational value comprises:
generating an identity matrix in the second coordinate system;
generating a transform matrix by applying at least one rotation about at least one axis of the identity matrix, so that the transform matrix encodes the at least one rotation; and
obtaining the rotational value by converting the transform matrix to a quaternion, wherein the quaternion encodes the at least one rotation.

8. The method according to claim 7, wherein the at least one rotation is selected from a group consisting of: a 90-degree rotation around a z-axis, a 180-degree rotation around the z-axis, a 270-degree rotation around the z-axis, and a 180-degree rotation around a y-axis.

9. The method according to claim 1, wherein aligning the image map with the model map comprises overlaying each pixel or voxel of the image map onto a corresponding pixel or voxel of the model map.

10. The method according to claim 1, wherein displaying the image comprises displaying the image as a hologram projected in the physical space.

11. The method according to claim 1, wherein the physical object is a patient, and the image is a radiological image of the patient.

12. A system for overlaying an image represented as an image map in a first coordinate system on a physical object represented as a model map in a second coordinate system, the system comprising:
at least one sensor operable to measure depth of the physical object in a physical space;
an extended reality (XR) device having a display operable to display an image in the physical space;
a processor in operative communication with the at least one sensor and the XR device; and
memory having instructions stored thereon which, when executed by the processor, cause the processor to:
instantiate a common coordinate system that unifies the first coordinate system and the second coordinate system;
dynamically recognize the physical object in the common coordinate system using the at least one sensor;
align the image map with the model map of the dynamically recognized physical object in the common coordinate system;
displaying the image in the physical space overlaid on the physical object using the display of the XR device.

13. The system according to claim 12, further comprising an imaging device configured to capture the image of the physical object.

14. The system according to claim 13, wherein the imaging device is configured to capture the image using electromagnetic radiation that is outside the visible spectrum.

15. The system according to claim 14, wherein the imaging device is a radiological imaging device, and wherein the image is a radiological image.

16. The system according to claim 15, wherein the physical object is a patient, and the image is a radiological image of at least one bone of the patient.

17. The system according to claim 12, wherein the XR device comprises a head-mounted display.

18. The system according to claim 17, wherein the at least one sensor comprises at least one camera provided on the head-mounted display.

19. The system according to claim 18, wherein the at least one camera comprises a stereoscopic camera.

20. A non-transitory computer-readable medium having instructions stored thereon which, when executed by a processor, cause the processor to carry out a method for overlaying an image represented as an image map in a first coordinate system on a physical object represented as a model map in a second coordinate system, the method comprising:
instantiating a common coordinate system that unifies the first coordinate system and the second coordinate system;
dynamically recognizing the physical object in the common coordinate system using at least one sensor;
aligning the image map with the model map of the dynamically recognized physical object in the common coordinate system; and
displaying the image in a physical space overlaid on the physical object using a display of an extended reality (XR) device.
